(19) United States
(12) Patent Application Publication
(10) Pub. No.: US 2007/0039941 A1
(43) Pub. Date: Feb. 22, 2007

(54) Cooking device

(75) Inventors: Ingo Bally, Traunstein (DE); Kerstin Feldmann, Nussdorf (DE); Wolfgang Fuchs, Altenmarkt a.d. Alz (DE); Martin Keller, Traunreut (DE); Edmund Kuttalek, Grassau (DE); Maximilian Neuhauser, Chieming/Egerer (DE); Klemens Roch, Trostberg (DE); Wolfgang Schnell, Trostberg (DE); Guenter Zschau, Traunreut (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 11/498,632

(22) Filed: Aug. 2, 2006

(30) Foreign Application Priority Data
Aug. 17, 2005 (DE) 10 2005 038 879.5

(51) Int. Cl. A21B 1/00; A21B 1/22; F27D 11/00

(52) U.S. Cl. 219/404

(57) ABSTRACT

The present invention provides a cooking device, especially a raised-level built-in cooking device, comprising at least one muffle defining a cooking chamber whose muffle opening is surrounded by a muffle frame, furthermore a door for closing the muffle opening which can be moved by means of a drive device and comprising at least one movement control panel for moving the door in a direction-dependent manner, wherein the door can only be moved when both movement control panels are actuated for movement of the doors in the same direction.

The present invention relates to a cooking device, especially a raised-level built-in cooking device, comprising at least one muffle defining a cooking chamber with a muffle opening, a door for closing the muffle which can be moved by means of a drive device and at least one movement control panel for moving the bottom door in a direction-dependent manner.

A generic raised-level built-in cooking device is known from DE 102 28 140 A1, wherein any jamming of objects at the bottom door can be identified by a plurality of independently actuated jam protection switches between the bottom door and the muffle frame. In this case, a pressure rise in a door seal with a hollow profile can additionally be evaluated.

DE 101 64 239 A1 describes a jam protection system which is triggered by different tensile forces on the tension cables driving the bottom door. Also described is a torque sensor which detects a load moment on the drive shaft of an electric motor. Tensile force sensors, piezoelectric sensors as well as deformation pr stress/strain tensors are specified as sensors.

DE 102 88 141 A1 also discloses an opto-electronic sensor for detecting a jam which is switched by the amount of reflected light.

A disadvantage with the known cooking device is that the free hand can still be jammed initially.

It is thus the object of the present invention to provide a cooking device with improved protection against jamming of a hand.

The present object is achieved by a cooking device having the features of claim 1 and the method according to claim 21.

For this purpose, provided on the cooking device, which is especially a raised-level built-in cooking appliance but can also have a baking carriage, are two movement control panels so that the door can only be moved when both movement control panels are actuated for movement of the door in the same direction. This normally two-handed operation prevents the free hand from becoming jammed.

The movement control panels can each comprise a toggle switch, for example which in one embodiment is switched by pressing in the desired direction of travel and returns to a neutral position after releasing. The movement of the door is thus normally effected with both hands.

Preferably, at least one movement control panel comprises its own movement button for each direction of travel, that is typically an opening “OPEN” switch and a closing “CLOSE” switch, e.g. push buttons. Thus, both “OPEN” switches must be actuated for movement of the door in the opening direction and both “CLOSE” switches must be actuated for movement of the door in a closing direction.

In order to force two-handed operation, the movement control panels or the movement buttons for the same direction of travel are at least 15 cm apart, which is larger than the hand span of a child. More favourably the movement control panels are at least 20 cm apart which is larger than the typical hand span of an adult. However, other dimensions, especially wider ones, can also be used, e.g. at least 25 cm or 30 cm.

It is advantageous for ease of operation if the movement control panels are disposed on a fixedly installed part of the appliance, especially if they are attached to the front side of a fixedly installable housing. However, they can also be attached to the sides of the fixedly installed housing; preferably on opposite sides. In general, the movement control panel can be freely arranged, that is for example, on the movable bottom door.

The door preferably starts to move gently, i.e. with a defined ramp, e.g. a speed or load ramp. On the other hand, for safety reasons it is favourable if the door is stopped abruptly, i.e. that the door stops immediately after releasing one of the movement panels, e.g. by short-circuiting the drive motor.

In a particularly favourable embodiment, the cooking device further has a memory unit for storing at least one target position of the door, wherein if a target position is stored, the door can be moved automatically by actuating one of the movement control panels for the corresponding direction until the next target position for this direction is reached. In this automatic mode, two-handed operation is thus not necessary since a risk of collision has already been reduced by storing the target position. The possibility of storing a target position is already new and is not obvious to the person skilled in the art.

The target position can be stored by actuating an actuating button when the door is at the target position. Then, at least one optical and/or acoustic signal generator (light/loudspeaker) is favourably activated to notify the user when the actuating button is actuated and the target position is thereby stored.

Whereas during two-handed operation, that is without a stored target position, a jam protection device can be deactivated without significant loss of safety, in automatic mode with a stored target position, the jam protection device is advantageously activated.

The memory unit favourably comprises volatile memory modules for storing the target position so that after disconnecting the appliance from the mains, e.g. during a move, the target position must be learned again. Advantageously, a power failure backup is then provided so that the target position need not be re-learned every time in the event of minor power failures or mains fluctuations.

It is furthermore advantageous for comfortable operation if, with a stored target position, that is in automatic mode, the door can start moving and/or be braked gently.

In any case, it is advantageous if the distance measurement can be automatically re-initialised at the zero position for the closed state. By this means the distance travel or the position of the door can always be re-aligned with the fixed zero position which makes the distance measurement more accurate. It is favourable if the distance travelled is measured incrementally, especially digitally and incrementally. In this case, it is very advantageous if the distance travelled is measured by at least one sensor, arranged on a motor shaft of the drive device, especially by a Hall sensor which emits two signal on each revolution of a motor shaft.

For easier operation, the drive device can advantageously be operated by actuating both movement control panels even when the main switch is switched off.

The invention is described in detail hereinafter with reference to the appended schematic figures. In the figures:

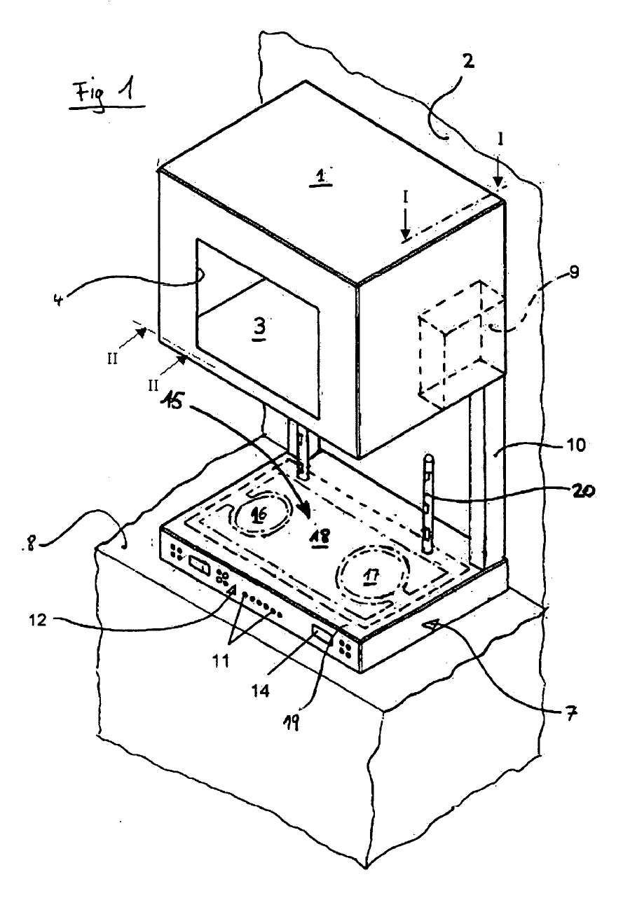

FIG. 1 is a perspective view of a raised-level built-in cooking appliance mounted on a wall with the bottom door lowered;

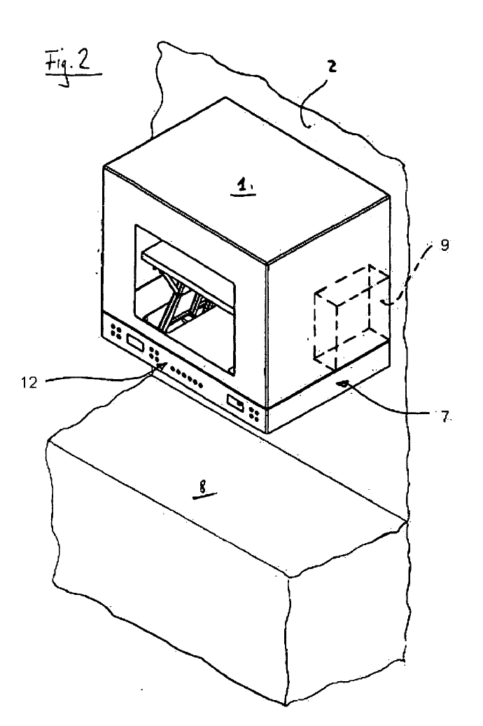

FIG. 2 is a perspective view of the raised-level built-in cooking appliance with the bottom door closed;

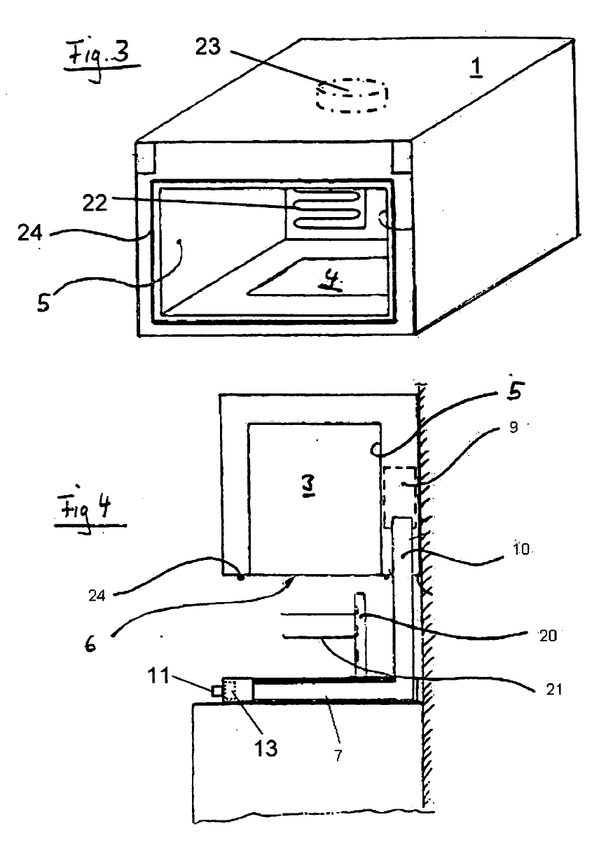

FIG. 3 is a perspective view of a housing of the raised-level built-in cooking appliance without the bottom door;

FIG. 4 is a schematic side sectional view of the raised-level built-in cooking appliance mounted on the wall with the bottom door lowered;

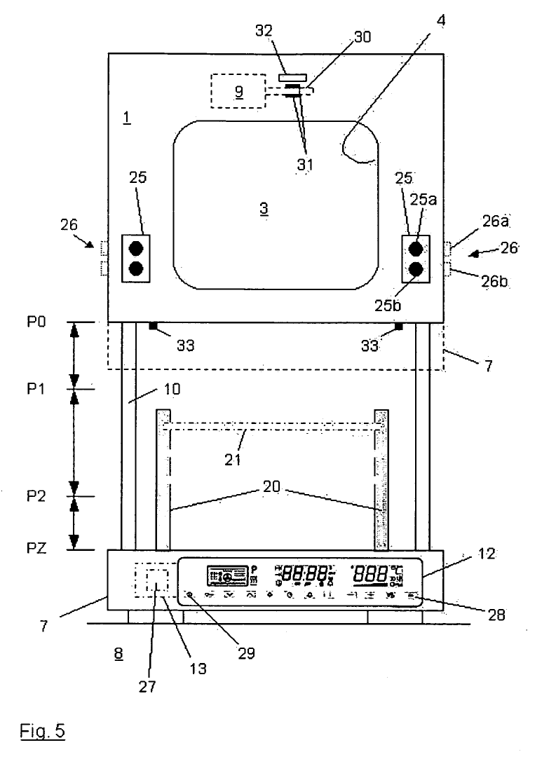

FIG. 5 is another embodiment of a raised-level built-in cooking appliance in front view.

FIG. 1 shows a raised-level built-in cooking appliance with a housing 1. The rear side of the housing 1 is mounted on a wall 2 in the manner of a wall cupboard. Defined in the housing 1 is a cooking chamber 2 which can be monitored by means of a viewing window 4 inserted in the front of the housing 1. It can be seen in FIG. 4 that the cooking chamber 3 is defined by a muffle 5 which is provided with a heat-insulating jacket not shown and that the muffle 5 has a muffle opening 6 at the bottom. The muffle opening 6 can be closed by a bottom door 7. In FIG, 1 the bottom door 7 is shown as lowered with its lower side in contact with a worktop 8 of a kitchen device. In order to close the cooking chamber 3, the bottom door 7 must be moved into the position shown in FIG. 2, the so-called “zero position”. The raised-level built-in cooking appliance has a drive device 9, 10 for moving the bottom door 7. The drive device 9, 10 has a drive motor 9 shown by the dashed lines in FIGS. 1, 2 and 4 which is located between the muffle 5 and an outer wall of the housing 1. The drive motor 9 is located in the area of the rear side of the housing 1 and, as shown in FIG, 1 or 4, is in operative connection with a pair of lifting elements 10 which are connected to the bottom door 7. As shown in the schematic side view from FIG. 4, each lifting element 10 is configured as an L-shaped support whose perpendicular leg extends from the housing-side drive motor 9. To shift the bottom door 7, the drive motor 9 can be actuated by means of a control panel 12 and a control circuit 13, which is located at the front of the bottom door 7 as shown in FIGS. 1 and 2. As shown in FIG. 4, the control circuit 13 is located behind the control panel 12 inside the bottom door 7. The control circuit 13, here composed of a plurality of spatially and functionally separate printed circuit boards communicating by means of a communication bus, forms central control unit for operation of the appliance and controls and/or regulates, for example, heating, movement of the bottom door 3, implementation of user inputs, lighting, jam protection, timing of heaters 16, 17, 18, 22 and much more.

It can be seen from FIG. 1 that an upper side of the bottom door 7 has a hob 15. Almost the entire area of the hob 15 is taken up by heaters 16, 17, 18 which are indicated by dot-dash lines in FIG. 1. In FIG, 1 the heaters 16, 17 are cooking point heaters of different size, spaced apart from one another whereas the heater 18 is a surface heater provided between the cooking point heaters 16, 17, which almost completely encloses the cooking point heaters 16, 17. The cooking point heaters 16, 17 define cooking zones or cooking surfaces relevant to the user; the cooking point heaters 16, 17 together with the surface heater 18 define an underheat zone. The zones can be indicated by suitable decoration on the surface. The heaters 16, 17, 18 can each be controlled by the control circuit 13.

In the exemplary embodiment shown the heaters 16, 17, 18 are configured as radiant heaters covered by a glass ceramic plate 19. The glass ceramic plate 19 has approximately the same dimensions as the upper side of the bottom door 7. The glass ceramic plate 19 is furthermore fitted with mounting openings (not shown) through which project the bases for holding retaining parts 20 for food carriers 21, as is also shown in FIG. 4. Instead of a glass ceramic plate 19, other, preferably rapidly responding covers can also be used, e.g. thin sheet metal.

The raised-level built-in cooking appliance can be switched to a cooking-point or underheat mode using a control lever provided in the control panel 12, as explained hereinafter.

In the cooking point mode, the cooking point heaters 16, 17 can be individually controlled by means of control elements 11, provided in the control panel 12 via the control circuit 13 whilst the surface heater 18 is out of operation. The cooking point mode can be executed when the bottom door 7 is lowered as shown in FIG. 1. However, it can also be operated in an energy-saving function when the cooking chamber 3 is closed with the bottom door 7 raised.

In the underheat mode not only the cooking point heaters 16, 17 but also the surface heater 18 are controlled by the control device 13.

In order to achieve a food browning pattern which is as uniform as possible during the underheat mode, it crucial that the hob 15 providing the underheat 15 has a uniform distribution of heat output over the surface of the hob 15 although the heaters 16, 17, 18 have different rated outputs. Thus, the heaters 16, 17, 18 are preferably not switched to continuous operation by the control circuit 13 but the power supply to the heaters 16, 17, 18 is intermittent. In this case, the different rated heat outputs of the heaters 16, 17, 18 can be reduced individually so that the heaters 16, 17, 18 create a uniform heat output distribution over the area of the cooking hob 15.

FIG. 4 schematically shows the position of a fan 23, e.g. for producing recirculated air during hot air operation or for supply fresh air. Also provided is an upper-heat heater 22 attached to an upper side of the muffle 5 which can be executed as single-circuit or multi-circuit, e.g. having an inner and an outer circuit. Further heaters such as a ring heater between the rear wall of the housing 1 and the muffle can also be provided, these not being shown here fore better clarity. The various operating modes such as, for example, upper heat, hot air or fast heating-up mode can be set by the control circuit 13 by appropriately switching on and adjusting the heating capacity of the heaters 16, 17, 18, 22, optionally with the fan 23 being activated. The heating capacity can be adjusted by suitable timing. In addition, the cooking hob 15 can be differently designed, e.g. with or without roasting zone, as a pure, single- or multi-circuit zone for keeping warm without cooktops and so on. The housing 1 has a seal 24 towards the bottom door 7.

The control panel 12 is fundamentally disposed on the front side of the bottom door 7. Alternatively, other arrangements are also feasible, e.g. in the front side of the housing 1, divided into various part panels and/or in part on side surfaces of the cooking device. Other configurations are possible. The control element s11 are not restricted in their design and can also comprise, for example, control levers, toggle switches, push buttons and film buttons comprising display elements 14, e.g. LED, LCD and/or touch screen displays.

FIG. 5 is a schematic diagram, not to scale, showing a raised-level built-in cooking appliance from the front where the bottom door 7 is open so that it rests on the worktop 8. The closed state is shown by the dashed line.

In this embodiment, two movement control panels 25 are located on the front side of the fixedly attached housing 1 on laterally opposed side areas of the viewing window 4. Each movement control panel 25 comprises two push buttons, an upper CLOSE push button 25a for a bottom door 7 moving upwards in the closing direction and a lower OPEN push button 25b for a bottom door 7 moving downwards in the opening direction. Without automatic operation (see below) the bottom door 7 only moves upwards, if possible, by simultaneously continuously pressing the CLOSE buttons 25a of both movement control panels 25; also, the bottom door 7 only moves downwards, if possible, by simultaneously continuously pressing the OPEN buttons 25b of both movement control panels 25 (manual operation). Since in manual mode, the operating attentiveness of the user is increased and in addition both hands must be used because the movement panels 25 or 26 are more than 20 cm apart, protection against jamming is only optional. In an alternative embodiment movement control panels 26 are attached on opposite outer sides of the housing 1 with corresponding CLOSE buttons 26a and OPEN buttons 26b.

The control circuit 13 shown by the dashed line, located inside the bottom door 7 behind the control panel 12 switches the drive motor 9 so that bottom door 7 starts to move gently, i.e., not abruptly by simply starting up the drive motor 9, but by means of a defined ramp.

In this exemplary embodiment, the control circuit 13 comprises a memory unit 27 for storing at least one target or travel position P0, P1, P2, PZ of the bottom door 7, preferably comprising volatile memory modules, e.g. DRAMs. If a target position P0, P1, P2, PZ is stored, after actuating one of the buttons 25a, 25b or 26a, 26b of the movement control panels 25 or 26, the bottom door 7 can move automatically in the set direction until the next target position is reached or one of the buttons 25a, 25b or 26a, 26b is actuated again (automatic mode). In this exemplary embodiment the lowermost target position PZ corresponds to maximum opening, the (zero) position P0 corresponds to the closed state and P1 and P2 are freely adjustable intermediate positions. If the last target position is reached for one direction, further movement must be made manually if this is possible (that is the last end positions do not correspond to the maximum open or closed final state). Similarly, if no target position is stored for one direction, which would be the case for example for an upward movement into the closed position if only PZ is stored but not P0, P1, P2, movement in this direction must be made manually. If no target position is stored, e.g. in a new installation or after disconnecting from the mains, automatic operation is not possible. When the bottom door 7 is moved in automatic mode, jam protection is preferably activated.

Automatic operation and manual operation are not mutually exclusive: by continuously actuating the control panel(s) 25, 26, the bottom door 7 also moves in manual mode if a target position were to be approached in this direction. In this case, a maximum actuation time can be specified for the control panels 25 or 26, or the relevant buttons 25a, 25b or 26a, 26b for activation of the automatic mode, e.g. 0.4 seconds.

A target position P0, P1, P2, PZ can be any position of the bottom door 7 between and including the zero position P0 and maximum opening position PZ. The maximum stored opening position PZ however must not be the position in contact with the worktop 8. A target position P0, P1, P2, PZ can be stored with the bottom door 7 in the desired target position P0, P1, P2, PZ by actuating an actuation button 28 in the control panel 12, for example, for a few seconds (e.g. two seconds continuously). Optical and/or acoustic signal generators which emit corresponding signal after storing a target position are not shown for better clarity. The desired target position P0, P1, P2, PZ to be set is approached for example by operating the movement control panels 25 or 26 with both hands, in this exemplary embodiment, and moving manually to this position.

Only one or, as shown in this exemplary embodiment, a plurality of target positions P0, P1, P2, PZ can be stored in the memory unit 27. If a plurality of target positions P0, P1, P2, PZ is stored, these can be successively approached by actuating the corresponding movement buttons 25a, 25b or 26a, 26b. By means of a plurality of target positions P0, P1, P2, PZ, the raised-level built-in cooking appliance can be conveniently matched to the desired operating height of several users. The target positions are advantageously deletable and/or overwritable. In one embodiment, for example, only one target position can be stored in the opened state whilst the zero position P0 is automatically recognised and can be approached automatically. Alternatively, the zero position P0 must also be stored so that it can be approached automatically.

It is especially advantageous for ergonomic usage if the or one target position P1, P2, PZ opens the bottom door 7 at least by about 400 mm to about 540 mm (that is P1−P0, P2−P0, PZ−P0≧40 cm to 54 cm). With this amount of opening the food carriers 21 can be inserted easily into the retaining parts 20. At the same time, it is favourable if the viewing window 4 is mounted approximately at eye level of the user or somewhat below, e.g. by means of a template which indicates the dimensions of the cooking device.

A power failure backup for covering a power failure of about 1 to 3 s, preferably up to 1.5 s power failure, is not shown.

The drive motor 9 from FIG, 1 has at least one sensor unit 31, 32 on a motor shaft 30, optionally disposed before or after a gear unit in order to measure a distance covered or a position and/or a speed of the bottom door 7. The sensor unit can for example comprise one or more induction, Hall, opto or OFW sensors and so on. In this case, two Hall (part) elements 31 are attached to the motor shaft 30 offset by 180°, that is oppositely located, and one Hall sensor 32 is attached in a fixed position at a distance in this area of the motor shaft, for simple measurement of distance and speed. If one Hall element 31 passes by the sensor 32 during rotation of the motor shaft.30, a measurement or sensor signal is produced which is to a good approximation digital. With (not necessarily) two Hall elements 31, two signals are therefore emitted during one rotation of the motor shaft 30. By making a time evaluation of these signals, e.g. their time different, the speed vL of the bottom door 7 can be determined, for example using comparative tables or converting in real time in the control circuit 13. A distance travelled or a position of the bottom door 7 can be determined by addition or subtraction of the measurement signals.

The speed can be controlled, for example, by means of a PWM-controlled power semiconductor.

For determination of the zero point, the distance measurement is automatically re-aligned on each approach by initialising in the zero position P0 of the bottom door 7 so that an incorrect sensor signal emission or reception is not handed down.

The drive motor 9 is operated by actuating both movement control panels 25 or 26 even when the main switch 29 is switched off.

Instead of two separate switches per movement panel 25, 26, it is also possible to have a single switch per movement panel e.g. a toggle switch with a neutral position which only switched when pressed. Other forms are also possible. The type of arrangement of the control elements 28, 29 of the control panel 12 is also not restricted.

The arrangement division of the control circuit 13 is flexible and not restricted, and thus can also comprise a plurality of boards, e.g. a display board, a control board an a lift board which are spatially separated.

A 4 mm degree of opening can be identified by limit switch 33 which deactivates a jam protection system when actuated.

The raised-level built-in cooking appliance can also be designed without a memory unit 27 whereby no automatic operation is possible. This can be appropriate for increased operating safety, e.g. as a protection against jamming.

### Reference List

1 Housing
2 Wall
3 Cooking chamber
4 Viewing window
5 Muffle
6 Muffle opening
7 Bottom door
8 Worktop
9 Drive motor
10 Lift element
11 Control element
12 Control panel
13 Control circuit
14 Display elements
15 Cooking hob
16 Cooking point heater
17 Cooking point heater
18 Surface heater
19 Glass ceramic plate
20 Retaining part
21 Food carrier
22 Upper heat heater
23 Fan
24 Seal
25 Movement control panel
25a Movement switch upward
25b Movement switch downward
26 Movement control panel
26a Movement switch upward
26b Movement switch downward
27 Memory unit
28 Actuating button
29 Main switch
30 Motor shaft
31 Hall element
32 Sensor
33 Limit switch
FT1 First force time profile
FT2 Second force time profile
P0 Zero position
P1 Intermediate position
P2 Intermediate position
PZ End position
R1 Speed ramp
R2 Speed ramp
vL Travel speed of bottom door

1-23. (canceled)

24. A cooking device, comprising at least a muffle with a muffle opening and forming a cooking chamber;
a door;
a drive device for moving the door to selectively close and open the muffle opening;
a first movement control panel for direction-dependent movement of the door;
a second movement control panel for direction-dependent movement of the door, the door being operatively connected to the first and second movement control panels such that the door can only be moved when both the first and second movement control panels are actuated for movement of the door in the same direction.

25. The cooking device according to claim 24, wherein at least of the first and second movement control panels comprises a toggle switch.

26. The cooking device according to claim 24, wherein each of the first and second movement control panels comprises its own movement button for each direction of travel.

27. The cooking device according to claim 24, wherein the first and second movement control panels are a selected one of at least 15 cm apart and at least 20 cm apart.

28. The cooking device according to claim 24, wherein the first and second movement control panels are attached to the front side of a fixedly installable housing.

29. The cooking device according to claim 28, wherein the first and second movement control panels are disposed on opposite side areas of a viewing window.

30. The cooking device according to claim 24, wherein the first and second movement control panels are attached to respective opposite sides of a fixedly installable housing.

31. The cooking device according to claim 24, wherein the door is operable to start to move gently.

32. The cooking device according to claim 24 and further comprising a memory unit for storing at least one target position of the door, wherein if a target position is stored, the door can be moved automatically in the corresponding direction as far as the target position by actuating one of the movement switches.

33. The cooking device according to claim 32, wherein the target position can be stored by actuating an actuating button when the door is at the target position.

34. The cooking device according to claim 33, wherein, when the actuating button is actuated and the target position thereby stored, at least one optical and/or acoustic signal generator is activated.

35. The cooking device according to claim 32, wherein a jam protection device is deactivated without a stored target position and is activated with a stored target position.

36. The cooking device according to claim 32, wherein the memory unit comprises volatile memory modules for storing the target position.

37. The cooking device according to claim 32, wherein, with a stored target position, at least one of a start up or the door and a braking gently of the door can be effected.

38. The cooking device according to claim 32 and further comprising a power failure backup.

39. The cooking device according to claim 32 and further comprising a distance measurement that can be re-initialized at the zero position.

40. The cooking device according to claim 32 and further comprising a means for measuring incrementally the distance traveled.

41. The cooking device according to claim 40, wherein the distance traveled is measured by at least one sensor, especially by a Hall sensor, arranged on a motor shaft of the drive device.

42. The cooking device according to claim 24, wherein the door can be moved when the main switch is switched off.

43. The cooking device according to claim 24, wherein the cooking device is in the form of a raised-level, built-in cooking appliance, the muffle opening is a bottom-side muffle opening, and the door is a bottom door.

44. A method for operating a cooking device comprising:
in a cooking device not having a stored target function and having at least a muffle with a muffle opening and forming a cooking chamber, a door, a drive device for moving the door to selectively close and open the muffle opening, a first movement control panel for direction-dependent movement of the door, and a second movement control panel for direction-dependent movement of the door, the door being operatively connected to the first and second movement control panels such that the door can only be moved when both the first and second movement control panels are actuated for movement of the door in the same direction, actuating the first and second movement control panels for movement in the same direction, whereby the door is thereby moved in this direction.

45. The method according to claim 44, wherein actuating the first and second movement control panels for movement in the same direction include operating movement buttons respectively associated with the first and second movement control panels with both hands.

46. The method according to claim 45, wherein, in an automatic mode, after actuating at least one of the movement buttons, the door is automatically moved in the corresponding direction of travel to the next target position provided.
